(19) United States
(12) Patent Application Publication
(10) Pub. No.: US 2018/0322567 A1
(43) Pub. Date: Nov. 8, 2018

(54) SYSTEM AND METHOD FOR FACILITATING A TRANSACTION

(71) Applicants: Foad Afshari, Reseda, CA (US); Joseph Symond, Redondo Beach, CA (US)

(72) Inventors: Foad Afshari, Reseda, CA (US); Joseph Symond, Redondo Beach, CA (US)

(21) Appl. No.: 15/772,251

(22) PCT Filed: Oct. 31, 2016
(86) PCT No.: PCT/US2016/059760

§ 371 Date: Apr. 30, 2018

Related U.S. Application Data
(60) Provisional application No. 62/248,288, filed on Oct. 29, 2015.

(51) Int. Cl. G06Q 30/08; G06F 3/0482; G06Q 30/06

(52) U.S. Cl. CPC G06Q 30/08; G06Q 30/0643; G06F 3/0482

(57) ABSTRACT

Various embodiments of the present disclosure can include a computer implemented method for facilitating a transaction. In some embodiments, the method can include receiving a selection from a user 122. In some embodiments, the method can include characterizing the selection 124 received from the user as a buy request associated with a vehicle. In some embodiments, the method can include receiving data 128 associated with the vehicle from the user. In some embodiments, the method can include performing an aggregated vehicle search 130 based on the data associated with the vehicle received from the user. In some embodiments, the method can include determining, with a computer, a source of data 136 accumulated as a result of the performance of the aggregated vehicle search.

### CROSS-REFERENCE TO RELATED APPLICATION

This application claims priority to U.S. provisional patent application No. 62/248,288 entitled “SYSTEM AND METHOD FOR FACILITATING A TRANSACTION, filed 29 Oct. 2015, which is hereby incorporated by reference as though fully set forth herein.

### BACKGROUND

### a. Field

This disclosure relates to a system and method for facilitating a transaction.

### b. Background Art

Multiple millions of new cars are sold each year in the United States alone, along with an even greater number of used cars. Currently, approximately 17 million new cars are sold annually and approximately 42 million used cars are sold annually. Handling the majority of these transactions are thousands of franchise dealerships and an even greater number of used car dealerships. The total number of car sales is divided between franchise dealerships, used car dealerships, and sales made by private parties. While some mechanisms exist that can aid in the sales of cars, these mechanisms can be antiquated, costly, incomplete, cumbersome, and ‘unfriendly’ to use.

### SUMMARY

Various embodiments of the present disclosure can include a computer implemented method for facilitating a transaction. In some embodiments, the method can include receiving a selection from a user. In some embodiments, the method can include characterizing the selection received from the user as a buy request associated with a vehicle. In some embodiments, the method can include receiving data associated with the vehicle from the user. In some embodiments, the method can include performing an aggregated vehicle search based on the data associated with the vehicle received from the user. In some embodiments, the method can include determining, with a computer, a source of data accumulated as a result of the performance of the aggregated vehicle search.

Various embodiments of the present disclosure can include a non-transitory computer-readable medium storing instructions to facilitate a transaction that are executable by a processing resource. In some embodiments, the instructions can be executed to receive a selection from a user. In some embodiments, the instructions can be executed to characterize the selection received from the user as a sell request associated with a vehicle. In some embodiments, the instructions can be executed to determine whether the sell request is a private sale request or a dealer sale request. In some embodiments, the instructions can be executed to populate the vehicle in a listing as at least one of the private sale request and the dealer sale request, based on the selection received from the user.

Various embodiments of the present disclosure can include a system for facilitating a transaction. In some embodiments, the system can include a processor and memory storing non-transitory computer-readable instructions, executable by the processor to receive a selection from a user. In some embodiments, the instructions can be executed to characterize the selection received from the user as a buy request associated with a vehicle. In some embodiments, the instructions can be executed to receive data associated with the vehicle from the user. In some embodiments, the instructions can be executed to perform an aggregated vehicle search based on the data associated with the vehicle received from the user. In some embodiments, the instructions can be executed to determine that a source of data accumulated via the aggregated vehicle search is external. In some embodiments, the instructions can be executed to display the data accumulated via the aggregated vehicle search with a view controller, based on the determination that the data accumulated via the aggregated vehicle search is external.

### BRIEF DESCRIPTION OF THE DRAWINGS

FIG. 1 depicts an example of an environment which can be implemented for facilitating a transaction, according to embodiments of the present disclosure.

FIG. 2 depicts a flow chart for facilitating a transaction, according to embodiments of the present disclosure.

FIG. 3 depicts a representative graphical user interface presenting user selectable options for facilitating a transaction, according to embodiments of the present disclosure.

FIGS. 4A and 4B depict a representative graphical user interface presenting user selectable data items for facilitating a transaction, according to embodiments of the present disclosure.

FIGS. 5A and 5B depict a representative graphical user interface that includes drop down menus for facilitating a transaction, according to embodiments of the present disclosure.

FIG. 6 depicts search results that have been generated and displayed on a representative graphical user interface, according to embodiments of the present disclosure.

FIGS. 7A to 7C depict details associated with a particular search result displayed on a representative graphical user interface, according to embodiments of the present disclosure.

FIG. 8 depicts a list of notifications presented on a representative graphical user interface, according to embodiments of the present disclosure.

FIG. 9 depicts a representative graphical user interface that lists conversation threads, according to embodiments of the present disclosure.

FIG. 10 depicts a user profile displayed on a representative graphical user interface, according to embodiments of the present disclosure.

FIG. 11 depicts user selectable options presented to a user on a representative graphical user interface, according to embodiments of the present disclosure.

FIGS. 12A to 12M depict representative graphical user interfaces configured to obtain data from a user, according to embodiments of the present disclosure.

FIG. 13A depicts a diagram of an example of a system for facilitating a transaction, according to embodiments of the present disclosure.

FIG. 13B depicts a diagram of an example of a computing device for facilitating a transaction, according to embodiments of the present disclosure.

FIG. 14 depicts a flow chart for conducting a transaction, according to embodiments of the present disclosure.

### DETAILED DESCRIPTION

Throughout the buying and selling of both new and used vehicles, a vast array of mostly antiquated, costly, incomplete, cumbersome, and ‘unfriendly’ mechanisms continue to be used to facilitate sales, marketing, customer management (including trust and confidence building), dealer management, inventory, financing, and after sales service and support. Current technology offerings only mildly improve the experience, but essentially an industry-wide overhaul is desperately needed.

In an example, currently, vehicles can be advertised via web sites associated with franchise dealerships and/or private used car dealerships, online classified ads, online auction sites, among other available online resources. A user that is attempting to search for a vehicle and/or a best price on a particular vehicle may visit each one of these separate resources to determine a best price on a vehicle in which they are interested. Furthermore, a user may need to use separate resources for buying, selling, trading their vehicle, etc. In addition, current resources that are available for a user to buy a vehicle online have introduced a problem that many users face, which is associated with selecting a car that fits their personal needs and/or preferences. For example, where a user visits a brick and mortar dealership, a sales person may be available to help a user select a car based on information that the user conveys to the sales person. Such resources may not be available online for a user. Embodiments of the present disclosure can provide a solution to these problems, as well as other problems that consumers and dealers alike face when using current resources to buy, sell, and/or trade a vehicle. For example, embodiments of the present disclosure can provide an application comprising computer executable instructions that are executable by a computing device to provide resources to a user for buying, selling, and/or trading a vehicle.

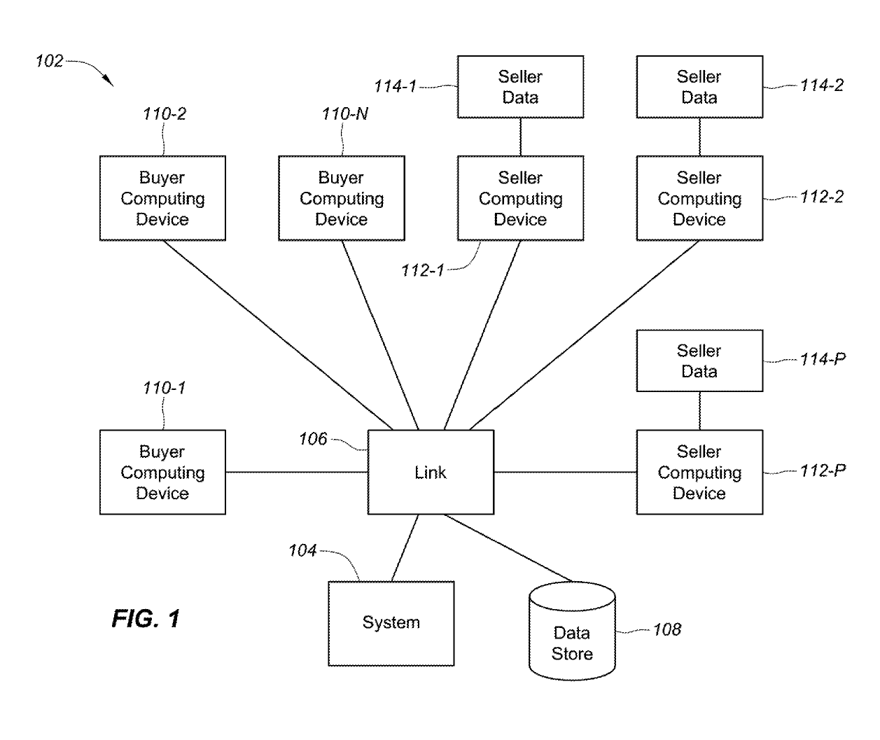

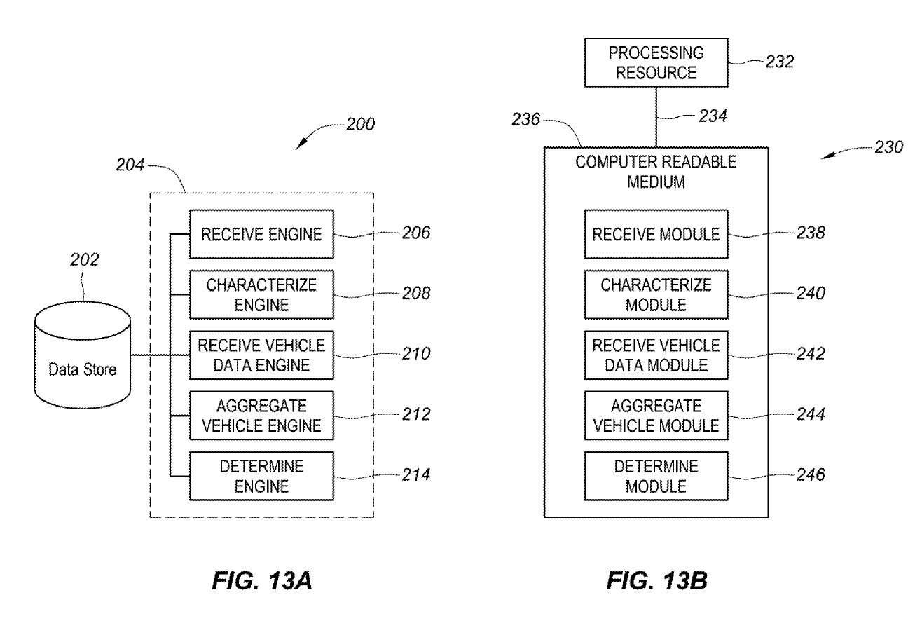

FIG. 1 depicts an example of an environment 102 which can be implemented for facilitating a transaction, according to embodiments of the present disclosure. The environment 102 is shown to include a system 104 to facilitate a transaction, buyer computing devices 110-1, 110-2, . . . , 110-N, seller computing devices 112-1, 112-2, . . . ,112-P, a data store 108, and a link 106. The data store 108 can be analogous to those discussed herein and with respect to FIG. 13A. The system 104 can include a computing device analogous to that discussed herein and with respect to FIG. 13B. The buyer computing devices 110-1, . . . ,110-N and seller computing devices 114-1, . . . , 114-P, as described herein, can be computing devices (e.g., electronic devices) and include, for example, features discussed below in relation to the system 104. In some embodiments, the computing devices can include a digital display such as a graphical user interface (GUI), which is suitable for the display of electronic data.

A user interface can include hardware components and/or computer-readable instruction components. For instance, hardware components can include input components (e.g., a mouse, a touchscreen, a keyboard, dials and buttons, etc.) and/or output components (e.g., a display, vibration generating devices, speakers, etc.). An example user interface can include a GUI, which can digitally represent data associated with facilitating a transaction. That is, in some examples, an electronic representation can be displayed by a user interface associated with buyer computing devices 110-1, . . . ,110-N and/or seller computing devices 112-1, . . . ,112-P. Such displays can facilitate interactions between a user and a computer (e.g., allows a user to interact with a computer using images and/or text).

Link 106 (e.g., local, wide area, regional, or global network) represents a cable, wireless, fiber optic, or remote connection via a telecommunication link, an infrared link, a radio frequency link, and/or other connectors or systems that provide electronic communication. That is, the link 106 can, for example, include a link to an intranet, the Internet, or a combination of both, among other communication interfaces. The link 106 can also include intermediate proxies, for example, an intermediate proxy server (not shown), routers, switches, load balancers, and the like.

The system 104 for facilitating a transaction, as described herein, can represent different combinations of hardware and instructions to facilitate a transaction. The system 104 for facilitating the transaction can include a computing device, for instance, computing device 230, as discussed in relation to FIG. 13B.

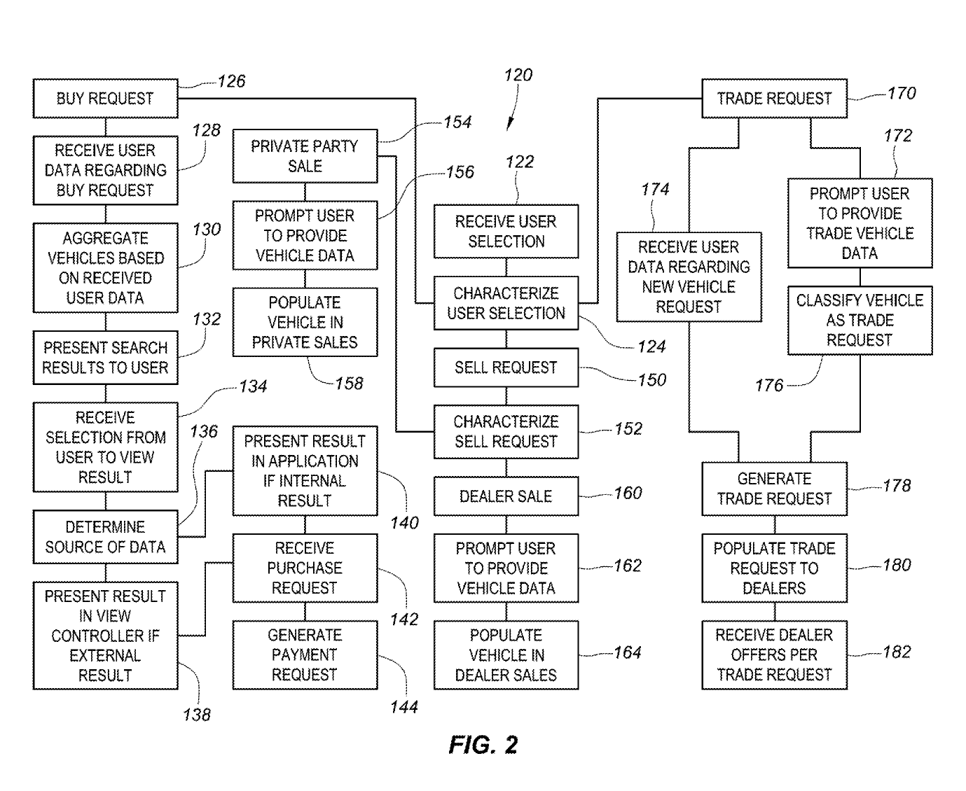

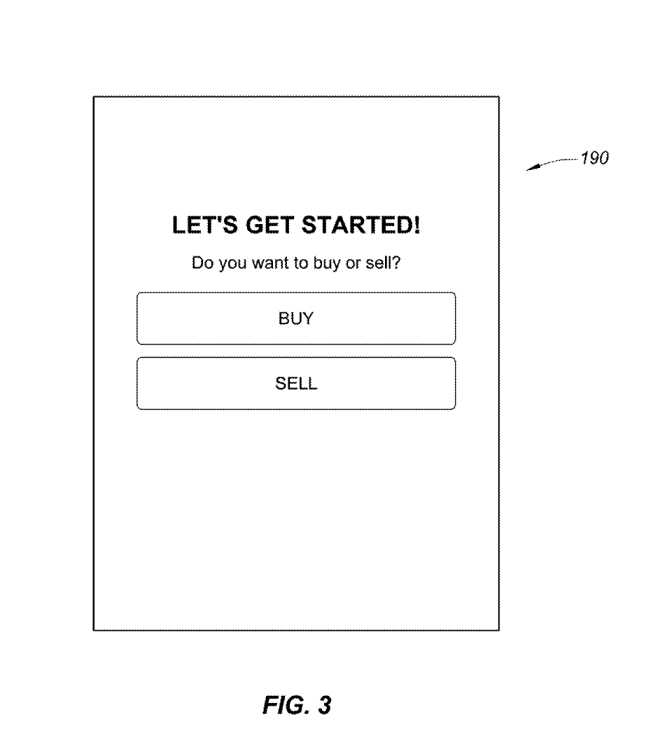

FIG. 2 depicts a flow chart for facilitating a transaction, according to embodiments of the present disclosure. In some embodiments, individual steps in the flow chart 120 can be representative of computer readable instructions that can be executed by one or more of the computing devices discussed herein. In some embodiments, individual steps in the flow chart 120 can represent method steps, which can be executed by the one or more computing devices discussed herein. In some embodiments, a user selection can be received at block 122. The user selection can be made by a user via a GUI associated with one or more of the buyer computing devices 110-1, . . . , 110-N and/or the seller computing devices 112-1, . . . ,112-P. In an example, the user selection can be one of a buy request, a sell request, a trade request, browse, certify, appraise, and/or finance. In some embodiments, the user selection can be characterized at block 124. Based on a selection made via a GUI 190 depicted in FIG. 3, the user selection can be characterized as a buy request, a sell request, or a trade request. For instance, if a user selects ‘BUY’ on the GUI 190, the user selection can be characterized as a buy request and if a user selects ‘SELL’ on the GUI 190, the user selection can be characterized as a sell request, based on the selection made via the GUI 190. In some embodiments, the GUI can include other input components, such as a microphone, and the user selection can be made via a voice command received by the microphone. In such an embodiment, the computing device can include voice recognition instructions, which can be used to characterize the user selection.

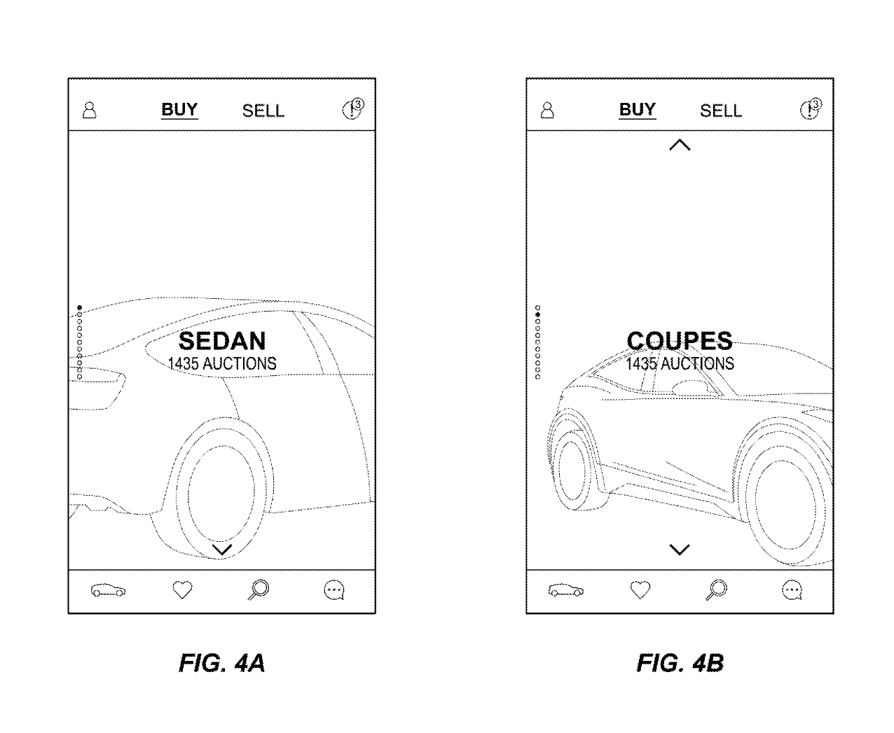

In some embodiments, where the user selection is characterized at block 124 as a buy request, control is transferred to block 126 and then, at block 128, user data regarding the buy request can be received. The user data regarding the buy request can be received via a selection made by a user on a menu that includes a number of selectable data items (e.g., a drop down menu). As depicted in FIGS. 4A and 4B, the selectable data items can be presented to a user in the form of separate pages, which can be swiped up or down via a touchscreen GUI. In an example, a user can select a type of vehicle via the selectable data items. For instance, the user can select a ‘SEDAN’ in FIG. 4A. Although reference in the present disclosure is made to vehicles, embodiments of the present disclosure can apply to other types of vehicles (e.g., all-terrain vehicles, motorcycles, boats, aircraft, etc.). In some embodiments, the user can swipe up on the GUI to reveal an alternate type of vehicle, such as ‘COUPES.’ In some embodiments, a user can select multiple types of vehicles, even though the vehicle selections are located on alternate pages. For instance, a user can maintain contact with a particular page presented on the GUI for a determined amount of time, such that the page is selected, but does not relay the selection. As such, the user can further select multiple other pages before relaying their selection of, for example, a type of vehicle.

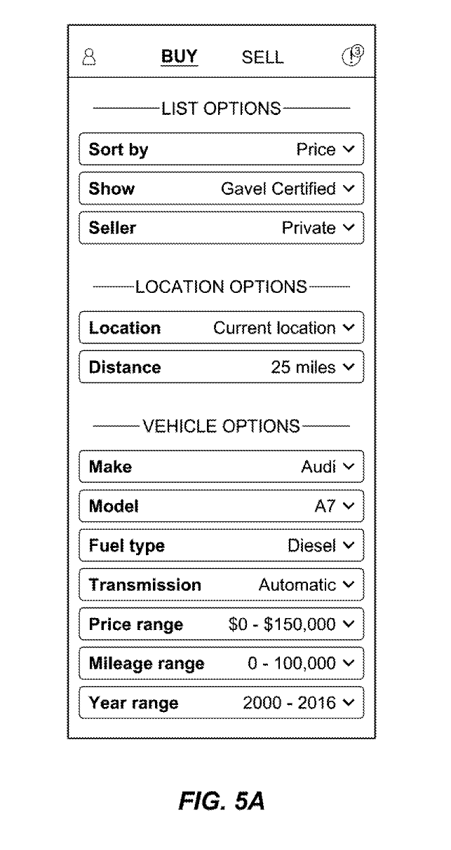

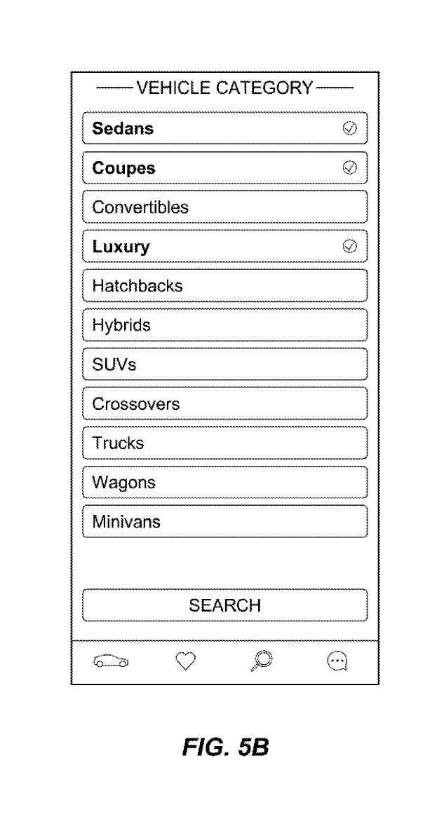

The selectable data items can be presented to a user in the form of a drop down menu, as discussed herein, such as that depicted in FIGS. 5A and 5B. In an example, vehicles can be sorted based on price, a type of seller (e.g., private, new car dealer, used car dealer), a certification, location, make, model, etc. In some embodiments, a user can select from multiple criteria to filter down to a type of vehicle they are searching for. The criteria can be dynamic and pulled from, for example, data store 108 (FIG. 1). This can allow adjustments to be made to the data that a user is presented without having to recompile the application. For example, based on a particular selection of a category, a next category for selection can be predictively populated and provided to the user for selection. Once a user has selected particular criteria, the user can select a search function to search based on the selected criteria.

In some embodiments, information can be received from the user regarding the buy request and the information can be analyzed to determine a type of vehicle and/or a particular vehicle that is suitable for the user based on suitability factors calculated according to, or based upon, the received information and information regarding the vehicle. For example, personal information can be obtained from the user, such as income, marital status, size of family, age, gender, anticipated activities that the vehicle will be used for, favorite color, personality type, etc. In some embodiments, a determination of a type of vehicle and/or particular features of the vehicle can be made based on the personal information obtained from the user. In some embodiments, preferred vehicle characteristics can be obtained from the user, such as a preferred color of paint, preferred color of the interior, preferred type of interior fabric, preferred type of car (e.g., truck, car, sedan, convertible, coupe, etc.) among other factors. In some embodiments, the preferred vehicle characteristics, such as preferred color, etc. can be ranked by the user and/or a weight (e.g., weighting factor) can be provided to one or more of the preferred vehicle characteristics. In an example, a plurality of characteristics associated with the preferred vehicle can be received from the user and a weighting factor associated with each one of the characteristics associated with the vehicle can be received. In another example, a plurality of desired characteristics associated with the vehicle and a rank of importance associated with each one of the plurality of desired characteristics can be received from the user. Based on the rank and/or weight of the preferred vehicle characteristics and/or the personal information obtained from the user, a particular type of vehicle and/or a vehicle with particular features can be selected for the user. For example, the preferred vehicle characteristics and/or personal information can be compared with specifications associated with particular vehicles, such as color, size, type of vehicle, a towing capacity, number of passengers that the vehicle can carry, engine size, rim size, etc. and a particular vehicle can be selected based on the comparison. In an example, a vehicle listing can be selected based on the rank of importance associated with each of the plurality of desired characteristics.

In some embodiments, the particular type of vehicle can be selected for the user based on their personal information and/or a combination of their personal information and/or the rank and/or weight of the preferred vehicle characteristics, whether that rank and/or weight is based upon information received from a particular buyer or general information about buyers of certain demographics. In some embodiments of the present disclosure, a data preparation stage, matching stage, and communication stage, such as that discussed in relation to U.S. Pat. No. 6,735,568, which is hereby incorporated by reference as though fully set forth herein, can be employed to determine a type of vehicle and/or a particular vehicle that is suitable for the user.

In some embodiments, the user data regarding the buy request can be received at block 128 via a search function. For example, a search field can be populated in which a user can enter search terms associated with a particular make, model, etc. of a vehicle.

In some embodiments, at block 130, one or more vehicles can be aggregated based on the received user data from block 128. In an example, multiple information sources and databases can be searched based on the received user data. The multiple information sources and databases can include, for example, local databases, such as data store 108, as depicted in FIG. 1, as well as third party databases, such as seller data 114-1, 114-2, . . . , 114-P. In some embodiments, third party databases can be associated with third party lead generators (e.g., Autotrader, Edmunds, Cars.com, etc.), eBay Motors, Craigslist, and dealer and manufacturer inventory systems. In some embodiments, application programming interfaces (API) can be accessed and data and/or listings can be pulled from databases associated with the APIs. In some embodiments, web scraping can be employed to pull data and/or listings can be pulled from sites (e.g., web sites) that do not employ APIs. In some embodiments, third party databases can be accessed (e.g., third party databases can be accessed via their associated application programming interfaces) and/or web scraping can be employed for each individual buy request submitted by an individual to gather data associated with one or more vehicles. Alternatively, or in addition, data store 108 can be periodically and/or continuously updated with information gathered from third-party databases and/or web scraping. Thus, in some embodiments, a searching (e.g., aggregation) time associated with a user buy request can be reduced by accessing the data regarding the buy request directly from the data store 108.

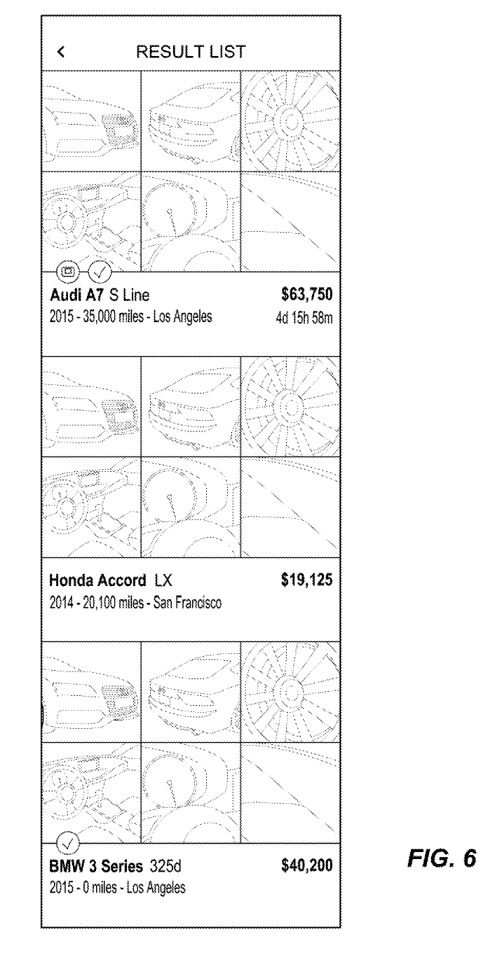

In some embodiments, search results can be presented to the user at block 132, based on the aggregated vehicles determined in block 130. In some embodiments, the search results can be presented to the user as depicted in FIG. 6. For instance, FIG. 6 depicts three search results that have been generated based on user data received at block 128.

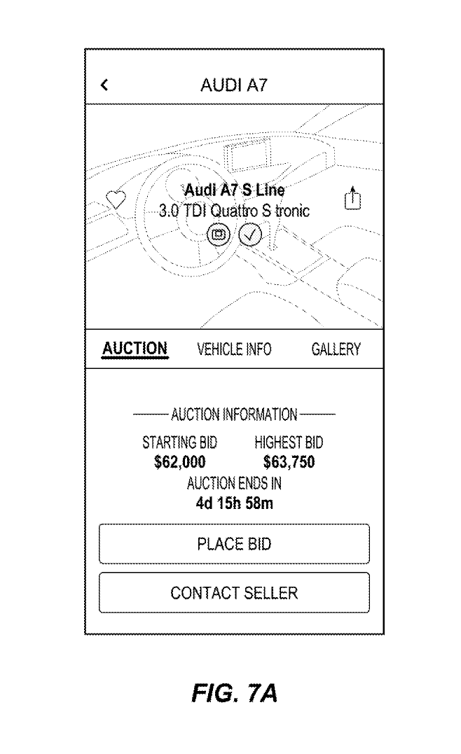

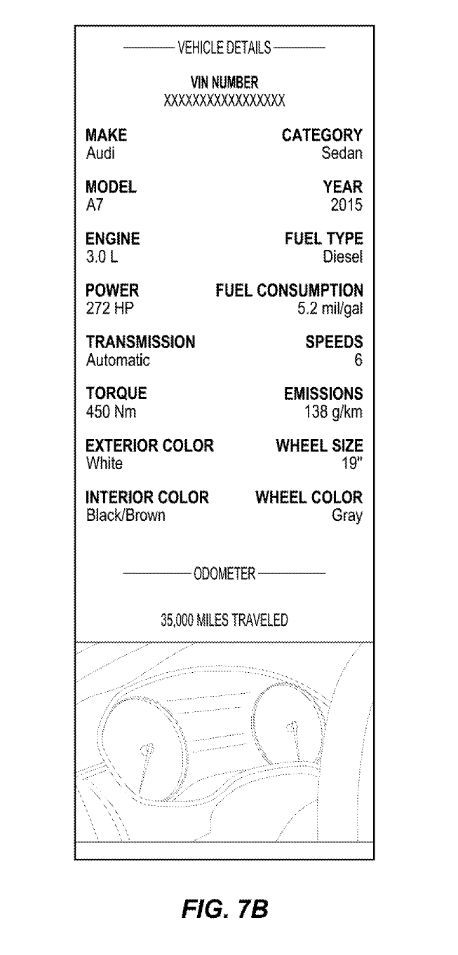

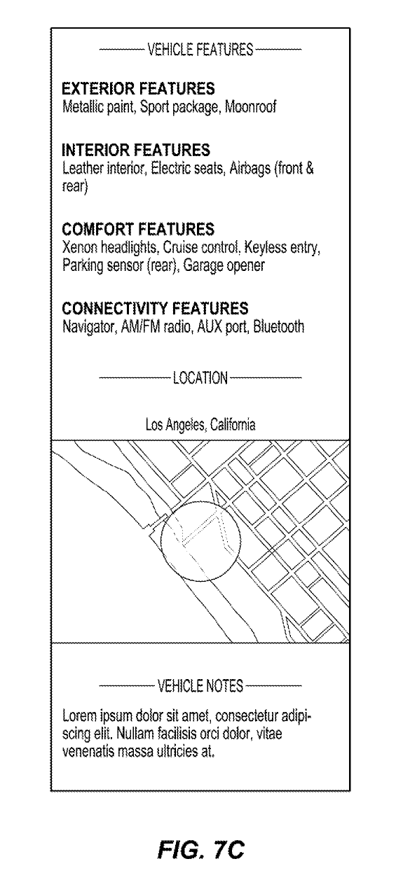

In some embodiments, at block 134, a selection can be received from a user to view a particular result included in the search results. In an example, a user can select the particular result by tapping on the result displayed on the GUI (where the GUI is a touchscreen). In some embodiments, the user can employ various other input components to select a particular result displayed on the search results. Based on the selection received from the user, information can be displayed to the user regarding the particular search result selected. For example, as depicted in FIGS. 7A to 7C, details associated with the particular search result can be displayed to the user, such as auction details (where the result is auction based), a price (where the result is a classified), offer details (where the result is being sold in relation to a best offer made), etc. Further details can include make, model, mileage, specifications associated with the vehicle (e.g., engine size, type of transmission, wheel size, color, etc.). In some embodiments, photos of the exterior and/or interior, videos of the exterior and/or interior, and/or a location of the vehicle can be displayed. In some embodiments, the location of the vehicle can be an approximate location, as depicted in FIG. 7C.

In some embodiments, although not depicted, a result field can be presented to the user that indicates why the vehicle was included in the search results. The result field can be displayed on the particular search result selected and/or can be displayed for each of the search results included in the list, as depicted in FIG. 6. The contents of the result field can be specifically based on user data that has been received from the user, in some examples. For instance, a number of passengers that the vehicle can carry, an amount that the vehicle can tow, wheel size, color, etc. can be displayed in the result field. In some embodiments, the contents of the result field can be specifically oriented to particular features of the vehicle that were obtained through the personal information and/or vehicle characteristics obtained from the user and/or can be specifically oriented to data assembled about the user and the vehicle generated in the matching state, as previously discussed. This can improve a user satisfaction with the populated search results, because the user can determine why each vehicle was included in the search results. The search result may include, for example, a list or grid showing the top factors (or all factors) causing a particular vehicle to be displayed, and may enable the user to alter and/or weight the criteria considered most relevant to the user and/or the buying decision (thereby training the system to better understand a particular buyer, type of buyer, demographic, etc.). In some embodiments, the altered criteria can be propagated to other users that are deemed to be similar. For example, in some embodiments, another user can select an option to have the system propagate the altered criteria to their own personal profile based on information gathered about the user to better enable the system to ‘pick’ a car that is judged to be suitable for the user.

In some embodiments, upon receiving the selection from the user to view a particular result at block 134, a determination of a source of the data associated with the particular search result that is being selected can be made. In an example where the source of data is internal (e.g., the ad was generated via the application and stored in the data store 108), the add can be presented in a format similar to or the same as that depicted in FIGS. 7A to 7C. In an example where the source of data is external (e.g., the ad was obtained from a third party via an API and/or web scraping), the result can be presented via a view controller (e.g., Safari View Controller) to the user. Thus, the result can be presented within the application without redirecting the user to a separate web page. In some embodiments, the source of the data can be considered external if the data is stored in an external database. For example, the data can be stored on a third party's database and/or the data can be stored on a database that is different than the data store 108.

In some embodiments, at block 142, a purchase request can be received from the user to buy the vehicle. In an example, a selectable option can be populated, allowing the user to contact the seller and/or allowing the user to buy the vehicle associated with the particular search result from the seller. In an example where the seller is a third party, communication between the user and the third party and/or a selection to purchase the vehicle from the third party can be made through the application, thus maintaining control over the communication/selection and for example, routing of funds from the user to the third party.

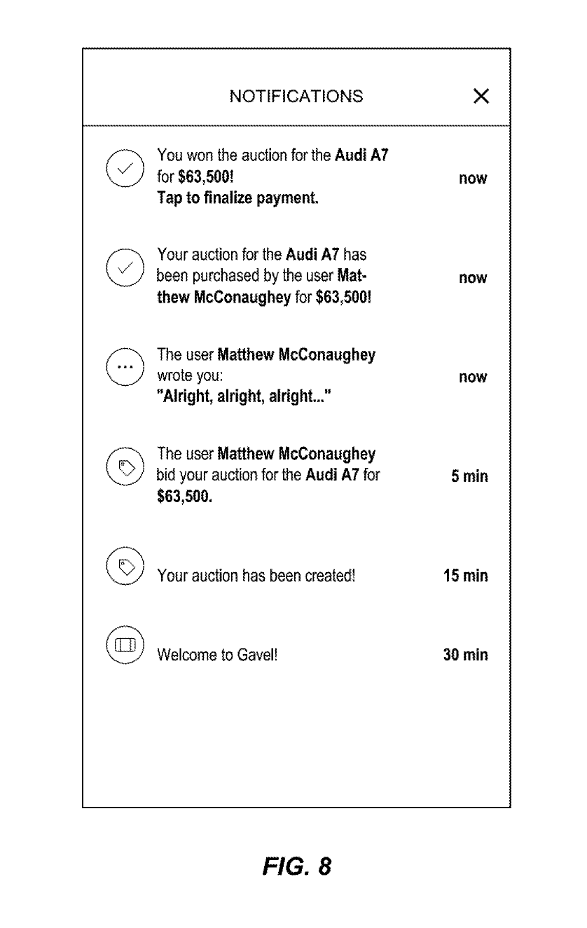

Upon purchasing the vehicle, a payment request can be generated at block 144, in some embodiments. For example, generation of the payment request can include sending an email to the user indicating that they have bought the vehicle and requesting that they pay for the vehicle. In some embodiments, the email can include an internet link that the user can select, which will direct them to a secure connection for entering their payment information. In some embodiments, as depicted in FIG. 8, a notification can be presented to the user that indicates that they have purchased the vehicle. The notification can be selectable by the user, in some embodiments. Upon receiving a selection of the notification, the user can be directed to a secure connection, for entering their payment information, as previously discussed.

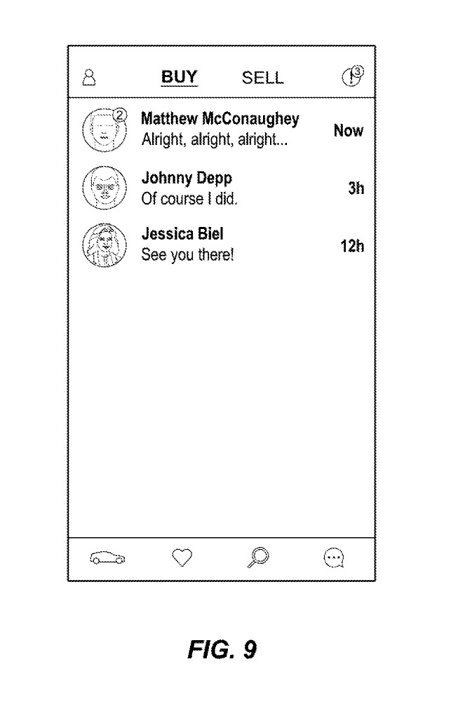

Some embodiments of the present disclosure can include a messaging application, which can be used to message other users (e.g., subscribers) of the application. The messaging application can be used to message other users, sellers, buyers, etc. As depicted in FIG. 8, notifications can include that a user has received a message from another user, which can be selected to direct the user to a particular page that displays a conversation between another one or more users. In some embodiments, different conversations can be displayed on a conversation screen, as depicted in FIG. 9. The conversation screen can display collapsed message threads between other users. Upon receiving a selection of a particular message thread, that message thread can be opened and the user can view a current and/or prior conversation with the other user. In addition, an input field can be provided and can be configured to receive text entered by the user for sending to another user.

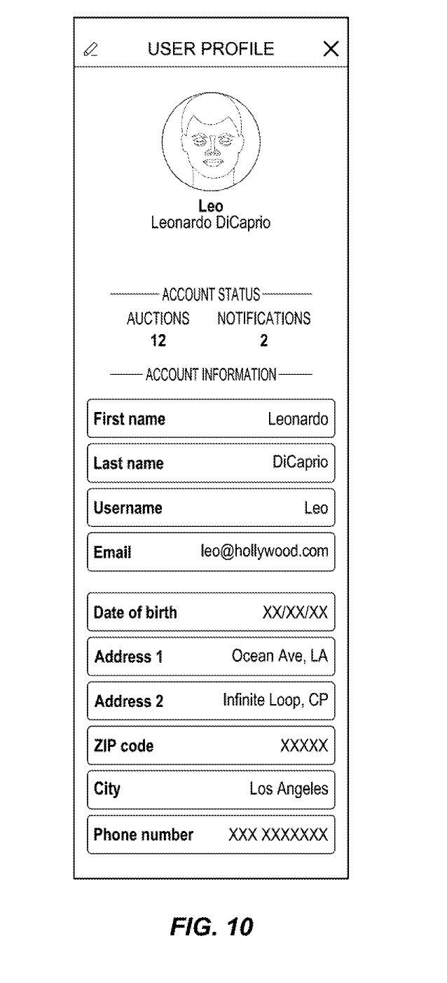

In some embodiments, users of the application can build user profiles, as depicted in FIG. 10, that list particular information about each individual user. The user profiles can be viewed by other users and/or by individual owners of each profile. In some embodiments, a user can select what information about their profile to share with other users. For example, a user can select to share their first name, last name, user name, email address, physical/home address, and city of origin, but choose to not share their date of birth, zip code, or phone number with other users.

In some embodiments, user profiles can include personal preferences associated with a type of vehicle that is desired by the user. For example, the user profile can include a type of vehicle and/or features associated with a vehicle that is desired by the user. In some embodiments, a user can chose to adopt another user's profile and search for vehicles based on the adopted user profile.

With further reference to FIG. 2, in some embodiments, the user selection can be characterized at block 124 as a sell request, transferring control to block 150. The user can generate the sell request via a selection made on the GUI 190 depicted in FIG. 3, by selecting the ‘SELL’ tab displayed on the GUI 190. In some embodiments, at block 152, the sell request can be characterized. The sell request can be characterized based on the type of party generating the sell request. In some embodiments, this information can be extracted from the user profile that has been generated by a user. For example, an indication can be provided in a user profile that indicates the user is a private party. In some embodiments, absent an indication that the user is a dealer, the user can be treated as a private party. Based on the indication that the user is a private party and/or based on an absence that the user is a dealer, the sell request can be characterized as a private party sale, at block 154.

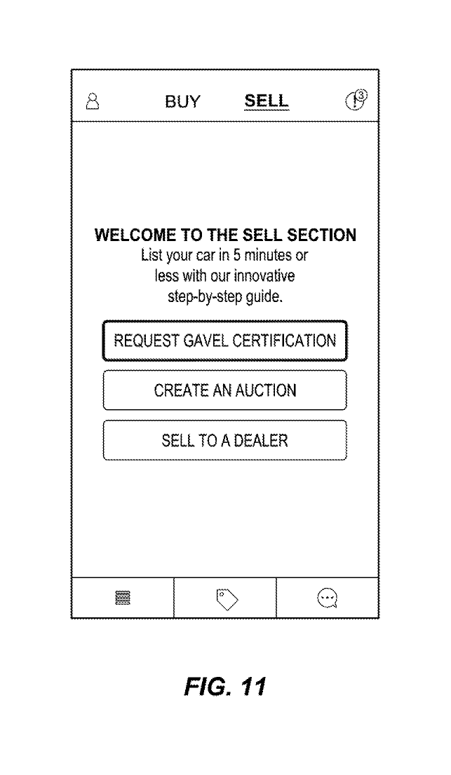

Upon creation of the sell request, one or more options can be presented to the user, as depicted in FIG. 11. The options can include one or more of requesting a certification, creating an auction, and/or selling to a dealer. Some embodiments of the present disclosure can provide an option to the user to request that their vehicle be certified by an inspector. In some embodiments, private party sellers can be required to obtain a certification by an inspector and the private party seller can be restricted from selecting an option on the GUI to create an auction and/or to sell to a dealer. Alternatively, in some embodiments, the user may not be required to obtain a certification of their vehicle to sell to a dealer, since dealers can be generally thought of as having more experience when buying vehicles and may wish to avoid purchasing cars that have had inspections completed in order to obtain a lower price on the vehicle. In some embodiments, the certification that the private party seller can be required to obtain can be a proprietary certification only offered through the application. In some embodiments of the present disclosure, an option can be provided to the user to sell their vehicle to a guarantee purchaser who is a third party offering a guaranteed purchase prices for the vehicle. In some embodiments, the guaranteed purchase price for the vehicle can be based on an inspection and/or certification provided by an inspector for the vehicle.

Upon receiving a selection made by a user via the GUI to receive a vehicle inspection, a notification can be sent to an inspection company through the messaging service included in the application. In some embodiments, an email or other form of electronic communication can be sent to the inspection company indicating that the user wishes to have an inspection completed on their vehicle. The inspection company may then contact the prospective seller through the messaging service included in the application or by other means of communication to set up an appointment to have an inspection completed.

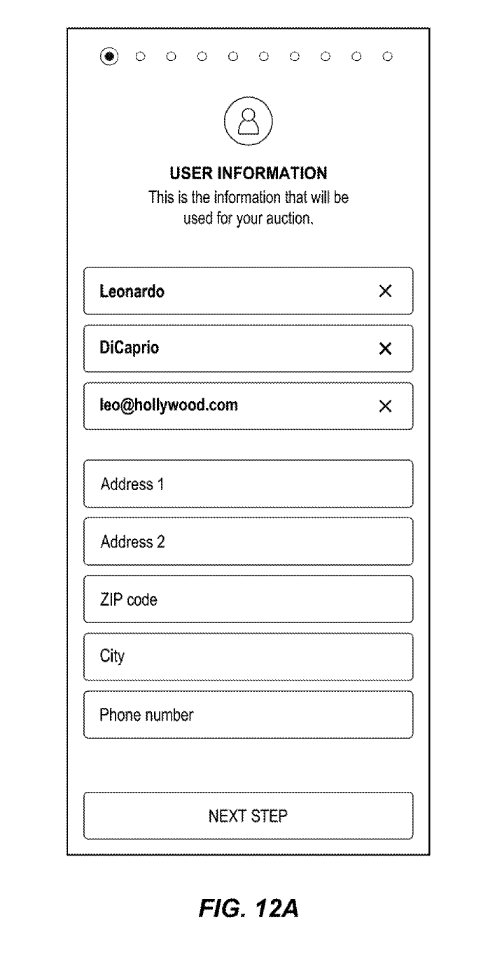

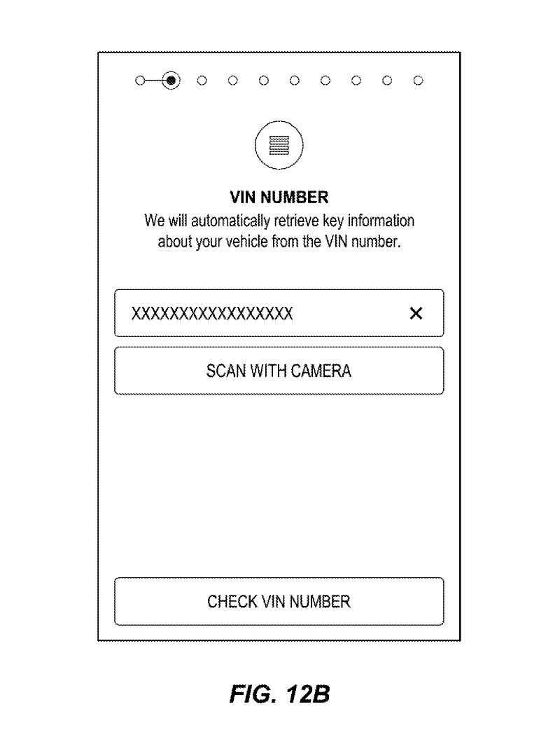

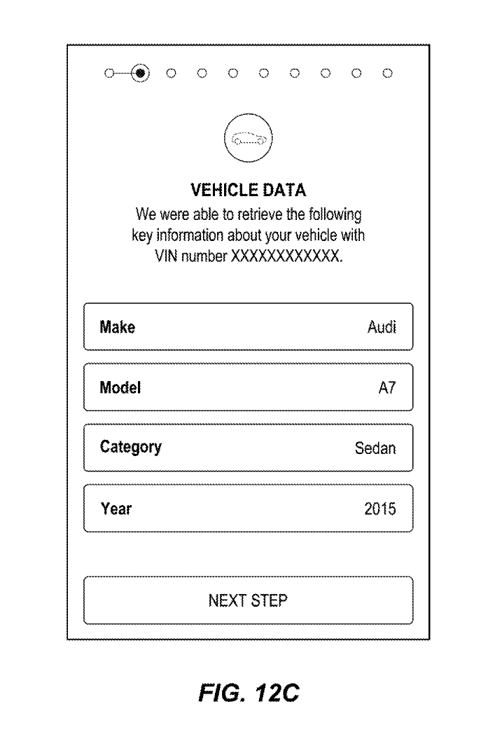

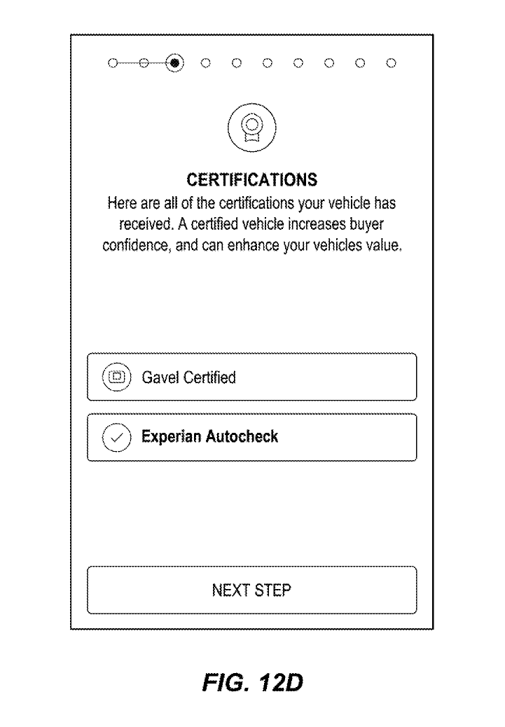

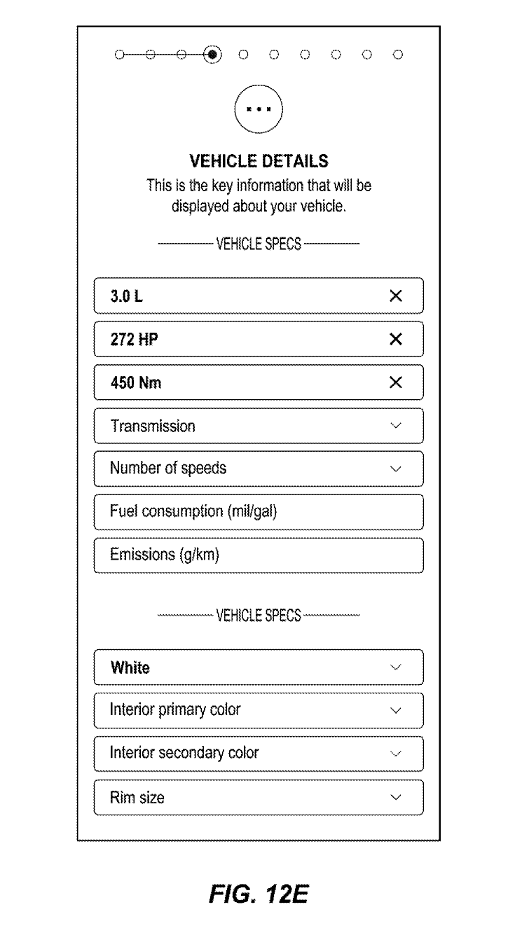

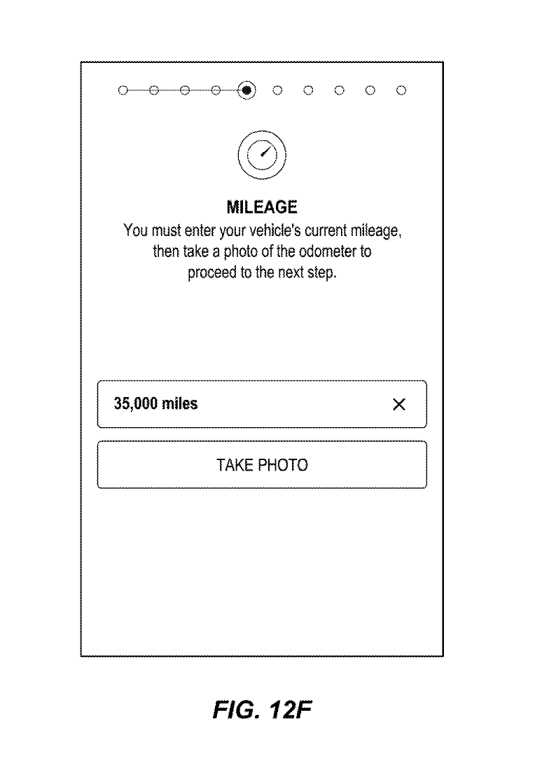

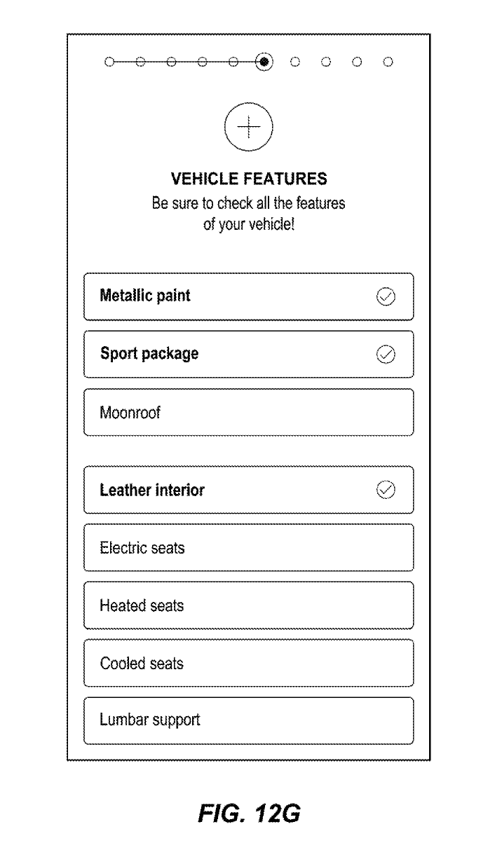

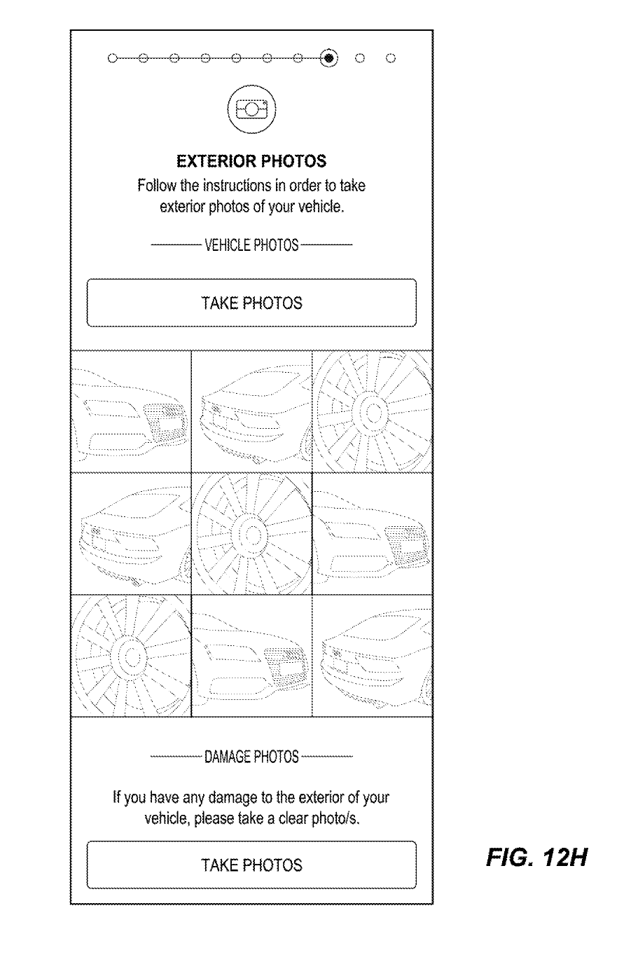

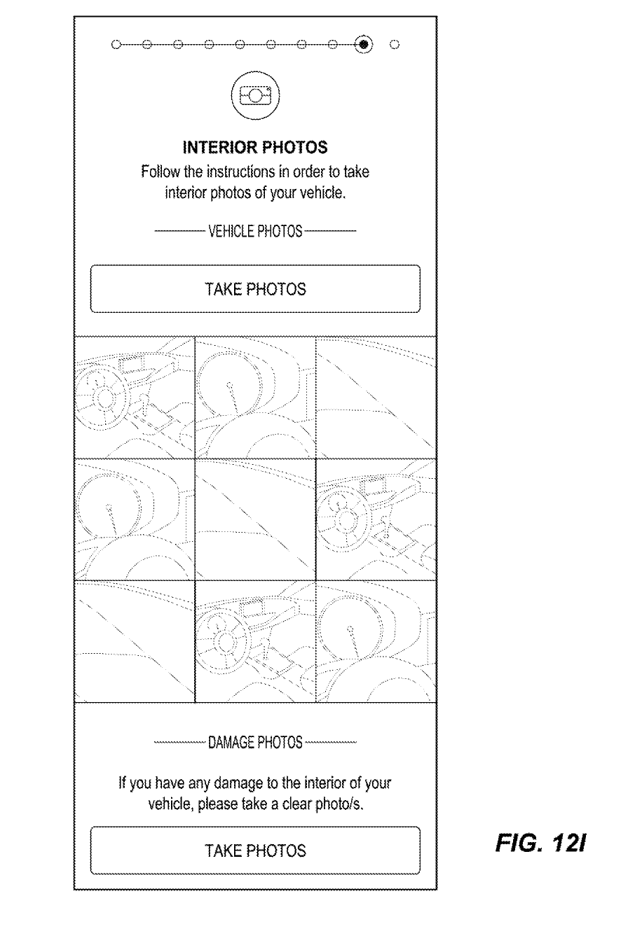

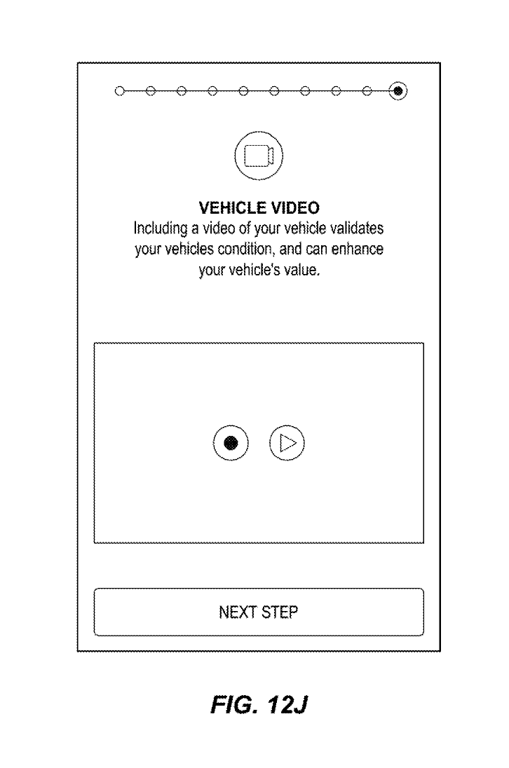

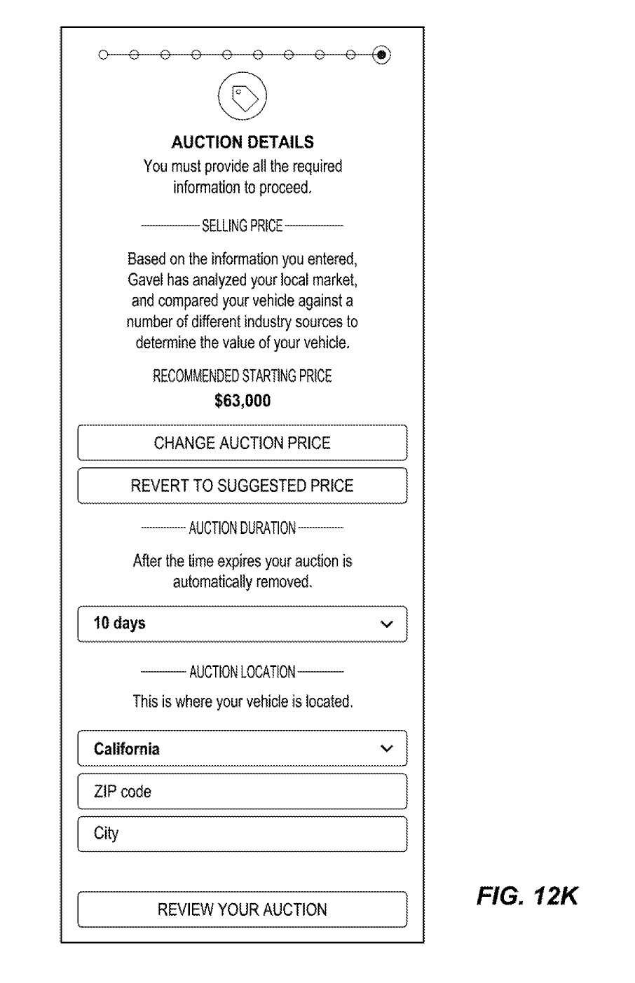

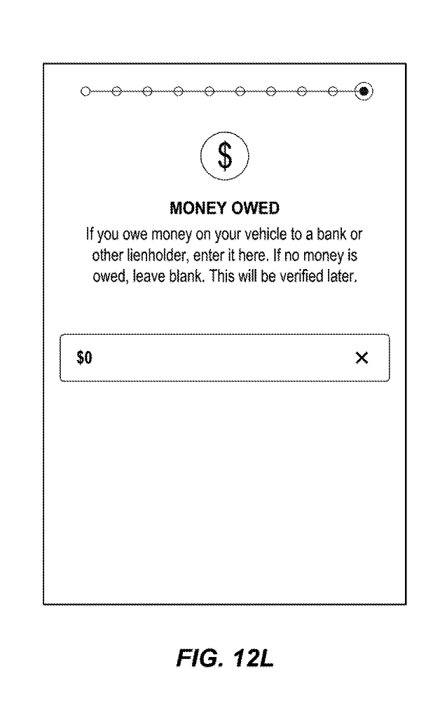

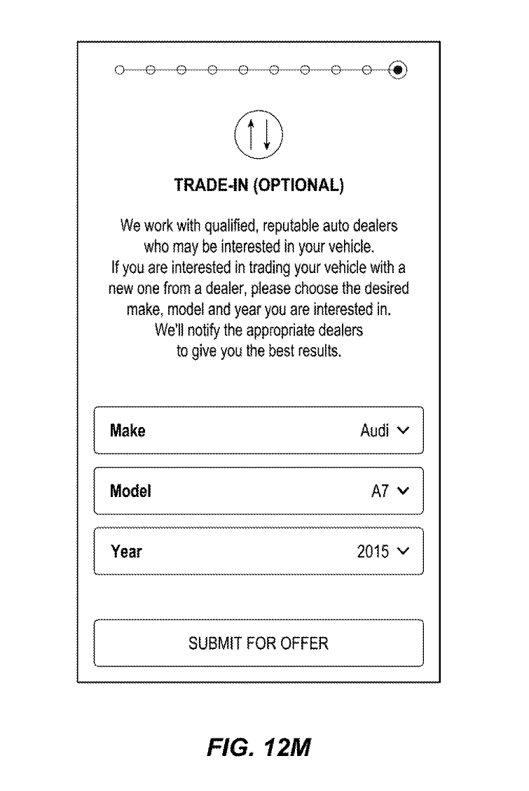

Once the inspection is completed, a code, or other form of authorization can be presented to the user or on behalf of the user indicating that the inspection was completed and details of the inspection can be received via the data store 108. The user can then be authorized to create an auction and the restriction to create an auction can be lifted, allowing the user to select the option presented on the GUI depicted in FIG. 12 to create an auction. Upon receiving a selection to create an auction, the user can be instructed step by step, as depicted in FIGS. 13A to 13M on the various aspects associated with creating the auction.

In some embodiments, at block 156, the user can be prompted to provide vehicle data associate with the vehicle that they are selling. For example, as depicted, in FIGS. 13A to 13M, multiple GUIs can be displayed to the user in succession in order to obtain information associated with the vehicle that the individual is selling. As depicted in FIG. 12A, user information can be obtained from the user, such as their name, email, address, etc. As depicted in FIG. 12B, the user can be requested to enter their vehicle identification number (VIN) into an entry field and/or the user can select an option to scan their VIN with a camera in communication with their user computing device. If the option to scan their VIN is selected, upon scanning of the VIN, the VIN can be automatically populated in the entry field thus alleviating the need to type the VIN into the entry field. As depicted in FIG. 12C, the user can be prompted to enter additional details associated with their vehicle via drop down menus, which can be predictive, as previously discussed.

In some embodiments, a certification page can be presented to a user, as depicted in FIG. 12D, which can display certifications that have been obtained with regard to the vehicle. In some embodiments, a certification can be obtained based on the VIN from a third party certification company. In some embodiments, the user may be allowed to proceed with the third party certification or the user may be required to obtain the proprietary certification, as discussed herein. As depicted, the proprietary certification can be ‘grayed out,’ if the certification has not been obtained. Once the proprietary certification is obtained, the certification can be made active and displayed in a manner analogous to how the third party certification (e.g., Experian AutoCheck) is displayed (e.g., not ‘grayed out’). Alternatively, if a particular certification has not been obtained, the certification may not be displayed at all.

As depicted in FIG. 12E, the user can select information that will be displayed regarding their vehicle on the listing. This information can include specifications and/or vehicle appearance information, in some embodiments. The user can be prompted to enter their a mileage associated with their vehicle, as depicted in FIG. 12F, and further be provided with a user selectable option to take a photo of an odometer associated with their vehicle, which upon selection can activate a camera in communication with the user computing device.

As depicted in FIG. 12G, the user can be prompted to select features associated with their vehicle, such as metallic paint, leather interior, cooled seats, etc. In some embodiments, the options presented on the GUI depicted in FIG. 12G can be based on a VIN associated with the vehicle that has been previously provided or a selection of a make and model of the vehicle that has been previously provided. In an example, user selectable options can be presented to the user. Each one of the user selectable options can be derived based on a vehicle identification number associated with the vehicle that is received from the user.

The user can be prompted to take photos of their vehicle, as depicted in FIG. 12H. In an example, the user can be individually prompted to take photos of different portions of their vehicle. For example, the user can be individually prompted to take photos of different portions of their vehicle in a predetermined order. For instance, the user can be prompted to take a photo of the right front passenger wheel and tire of the vehicle. Upon taking the photo of the right front wheel, the user can next be provided with a prompt to take a photo of the right front quarter panel of the vehicle. Upon taking the photo of the right front quarter panel of the vehicle, the user can be prompted to take a photo of the bumper and grill of the vehicle. The prompts can be provided to the individual so they take photos of each portion of the car in sequential order as they pass counter-clockwise or clockwise around the car. This can improve an efficiency of the user taking photos of the vehicle and thus improve an overall perception of the application. Further, this can provide an increase in the number of and quality of the photos taken of the vehicle, which can provide an increased satisfaction among prospective buyers of the vehicle and an increased buyer satisfaction of the application.

As further depicted in FIG. 12H, the user can be prompted to take photos of damage of the vehicle. In some embodiments, the user can be prompted to take photos of the interior of the vehicle, as depicted in FIG. 12I. The user can be prompted to take photos of each portion of the interior of the vehicle in a similar manner as that discussed in relation to FIG. 12H. In some embodiments, the user can be prompted to take photos of the interior in a predetermined order. For instance, the user can be prompted to take photos of the driver seat and surrounding area of the vehicle; next be prompted to take photos of the left rear passenger seat of the vehicle; next be prompted to take photos of the truck of the vehicle; next be prompted to take photos of the right rear passenger seat of the vehicle; and finally be prompted to take photos of the front passenger seat of the vehicle (e.g., in a counter-clockwise or clockwise manner).

As depicted in FIG. 12J, the user can be prompted to take a video of the interior and/or exterior of the vehicle. Upon completion of one or more of the preceding steps, a recommended auction and/or selling price can be generated based on data collected from the one or more preceding steps. For example, based on information entered, such as the local market, obtained by a location entered by the user, and other vehicle specific information, such as mileage, options, damage, etc., a recommended starting price can be generated and displayed to the user. Furthermore, in some embodiments, a user electable option to change the suggested price and/or to revert to the suggested price (after the suggested price has been changed by the user) can be populated and displayed by the graphical user interface displayed in FIG. 12K. In some embodiments, an entry field can also be displayed to the user to indicate a location where the sale of the car will take place.

In some embodiments, an option can be presented to the user, as depicted in FIG. 12L to enter an amount of money owed on the vehicle in an example where a loan was taken out on the vehicle. In some embodiments, if money is owed on the vehicle, details associated with the loan organization and/or individual can be entered into the field. Upon sale of the car, a notification can be sent to the loan company based on the information entered by the user, as discussed herein (e.g., VIN, first name, last name, address, etc.) of the pending sale and/or sale and a remaining balance of the loan can be transferred to the loan company upon receipt of the sale price from the buyer. In some embodiments, additional verification steps can be provided to ensure a proper transfer of funds to the loan company.

In some embodiments, the sell request 150 can be characterized at block 152 as a dealer sale 160. The sell request 150 can be characterized as a dealer sale 160, based on a selection made by the user. In a manner analogous to that discussed in relation to block 156, the user can be prompted to provide vehicle data associated with their vehicle at block 162. For example, upon receiving a selection from the user to sell their car, a further user selectable option can be presented to the user to select whether to classify the sale as a private party sale 154 or as a dealer sale 160. Upon receipt of the vehicle data, the vehicle can be populated in a dealer sales category at block 164. In some embodiments, by populating the vehicle in the dealer sales category, viewing of the vehicle may be restricted to dealers and private parties can be restricted from viewing the listing associated with the vehicle. In some embodiments, a private party can be distinguished from a dealer, as discussed herein.

As further discussed herein, the user may not be required to receive a vehicle certification when listing the vehicle in the dealer sales category. In some embodiments of the present disclosure, private party to dealer transactions, private party to private party, dealer to private party, and/or dealer to dealer transactions can be facilitated.

In some embodiments, the user selection can be characterized at 124, as a trade request 170. Some embodiments of the present disclosure can facilitate a trade made between a private party and a dealer, between two dealers, and/or between two private parties. Upon characterization of the user selection as a trade request, the user can be prompted to provide user data regarding a new vehicle request, at block 174, and as depicted in FIG. 12M. For example, in some embodiments, user data associated with the new vehicle request can be received in a manner analogous to that discussed in relation to receiving user data regarding a buy request, at block 128. Additionally, the user can be prompted to provide trade vehicle data, at block 172. The trade vehicle data can include information associated with the vehicle that is to be traded by the user. In some embodiments, the trade vehicle data can be received from the user in a manner analogous to that discussed in relation to prompting the user to provide data associated with their vehicle, as discussed in relation to block 156. In some embodiments, the vehicle can be classified as a trade request, at block 176.

A trade request can be generated at block 178, which can include user data regarding the new vehicle request and trade vehicle data, along with other information such as information associated with the user profile. In some embodiments, the trade request can be presented to the user for review and approval and the user can be provided with a user selectable option to edit the trade request or to confirm the trade request. In some embodiments, the trade request can be populated to dealers for review. In an example, a notification can be sent to one or more dealers indicating that the trade request has been generated. In some embodiments, the trade request can be stored in the data store 108 and dealers can perform a search that includes one or more key data items associated with the trade request. In response to the search, the trade request can be populated and displayed to the dealer, in a manner analogous to that discussed in relation to FIG. 6.

In some embodiments, dealer offers can be received per the trade request, at block 182. In an example, the offers can be best offers made by the dealer regarding the trade request, in some embodiments. In some embodiments, the user can specify a particular amount that they wish to trade for and the offer can be accepted by the dealer. In some embodiments, the user can generate a reverse auction, where dealers can bid in decreasing amounts, thus generating a lowest trade price for the individual. For example, a user could specify an auction to start at $5,000 to make the trade and each dealer could provide bids of decreasing amounts to win the buyer's business. For example, a first dealer could bid $4,500 and a second dealer could bid $4,200 to make the trade, thus providing the user with the lowest available price to make the trade.

FIG. 13A depicts a diagram of a system 200 for facilitating a transaction, according to embodiments of the present disclosure. The system 200 can include a data store 202 (e.g., analogous to data store 108 as referenced in FIG. 1), a facilitating system 204, and/or a number of engines. The facilitating system 204 can be in communication with the data store 202. The facilitating system 204 can include a number of engines (e.g., receive engine 206, characterize engine 208, receive vehicle data engine 210, aggregate vehicle engine 212, determine engine 214, etc.). The facilitating system 204 can include additional or fewer engines than illustrated to perform the various functions described herein. The number of engines can include a combination of hardware and programming to perform a number of functions described herein (e.g., accessing and/or aggregating data, etc.). Each of the engines can include hardware or a combination of hardware and programming designated or designed to execute a module (e.g., a particular module). The programming can include instructions (e.g., software, firmware, etc.) stored in a memory resource (e.g., computer-readable medium) as well as a hard-wired program (e.g., logic). In some embodiments, the instructions can be method steps that are executed by the processing resource 232 (FIG. 13B).

The receive engine 206 can include hardware and/or a combination of hardware and programming to receive a selection from a user. In some embodiments, the selection can be associated with at least one of a buy request, a sell request, and a trade request, as discussed herein. In some embodiments, the request can be received from the user via a GUI associated with a user computing device.

The characterize engine 208 can include hardware and/or a combination of hardware and programming to characterize the selection as a buy request based on the selection from the user. For example, in some embodiments, multiple user selectable options can be presented to a user on a GUI. Based on what option the user selects (e.g., where on the GUI the user selects), the user selection can be characterized as one of a buy request, a sell request, and/or a trade request.

The receive vehicle data engine 210 can include hardware and/or a combination of hardware and programming to receive vehicle data associated with a vehicle that is a subject of a buy request. In an example, the vehicle data associated with the vehicle that is the subject of the buy request can be received from a user, as discussed herein. The aggregate vehicle engine 212 can include hardware and/or a combination of hardware and programming to aggregate vehicles based on the received vehicle data. As discussed herein, in some embodiments, application programming interfaces (API) can be accessed and data and/or listings can be aggregated from databases associated with the APIs based on the received vehicle data. In some embodiments, web scraping can be employed to aggregate data and/or listings can be aggregated from sites (e.g., web sites) that do not employ APIs.

The determine engine 214 can include hardware and/or a combination of hardware and programming to determine a source of data associated with an aggregated vehicle selected by the user. In some embodiments, as discussed herein, if the source of data is from an external result, the result can be presented in a view controller. If the result is an internal result, the result can be presented in the application by displaying information stored in an internal database that is associated with the application in response to a determination that the result is an internal result. In some embodiments, further hardware and/or a combination of hardware and programming can be employed to implement various other functions, as discussed herein, such as receive a purchase request from the user and generate a payment request from the user.

FIG. 13B depicts a diagram of an example of a computing device 230 for facilitating a transaction according to the present disclosure. The computing device 230 can utilize software, hardware, firmware, and/or logic to perform a number of functions described herein.

The computing device 230 can be a combination of hardware and instructions to share information. The hardware, for example can include a processing resource 232 and/or a memory resource 236 (e.g., computer-readable medium (CRM), database, etc.). A processing resource 232, as used herein, can include a number of processors capable of executing instructions stored by the memory resource 236. Processing resource 232 can be integrated in a single device or distributed across multiple devices. The instructions (e.g., computer-readable instructions (CRI)) can include instructions stored on the memory resource 236 and executable by the processing resource 232 to implement a desired function (e.g., determine a source of data, etc.).

The memory resource 236 can be in communication with the processing resource 232. The memory resource, as used herein, can include a number of memory components capable of storing instructions that can be executed by the processing resource 232. Such memory resource 236 can be a non-transitory CRM. Memory resource 236 can be integrated in a single device or distributed across multiple devices. Further, memory resource 236 can be fully or partially integrated in the same device as processing resource 232 or it can be separate but accessible to that device and processing resource 232. Thus, it is noted that the computing device 230 can be implemented on a support device and/or a collection of support devices, on a mobile device and/or a collection of mobile devices, and/or a combination of the support devices and the mobile devices.

The memory 236 can be in communication with the processing resource 232 via a communication link 234 (e.g., path). The communication link 234 can be local or remote to a computing device associated with the processing resource 232. Examples of a local communication link 234 can include an electronic bus internal to a computing device where the memory resource 236 is one of a volatile, non-volatile, fixed, and/or removable storage medium in communication with the processing resource 232 via the electronic bus.

The memory resource 236 can include a number of modules such as a receive module 238, a characterize module 240, a receive vehicle data module 242, an aggregate vehicle module 244, and a determine module 246. The number of modules 238, 240, 242, 244, 246 can include CRI that when executed by the processing resource 232 can perform a number of functions. The number of modules 238, 240, 242, 244, 246 can be sub-modules of other modules. For example, the receive module 238 and the characterize module 240 can be sub-modules and/or contained within the same computing device. In another example, the number of modules 238, 240, 242, 244, 246 can comprise individual modules at separate and distinct locations (e.g., CRM, etc.).

Each of the number of modules 238, 240, 242, 244, 246 can include instructions that when executed by the processing resource 232 can function as a corresponding engine as described herein. For example, the aggregate vehicle module 244 can include CRI that when executed by the processing resource 232 can function as the aggregate vehicle engine. For instance, the aggregate vehicle module 244 can include CRI that when executed by the processing resource 232 can cause a computing device to aggregate vehicles based on the received vehicle data.

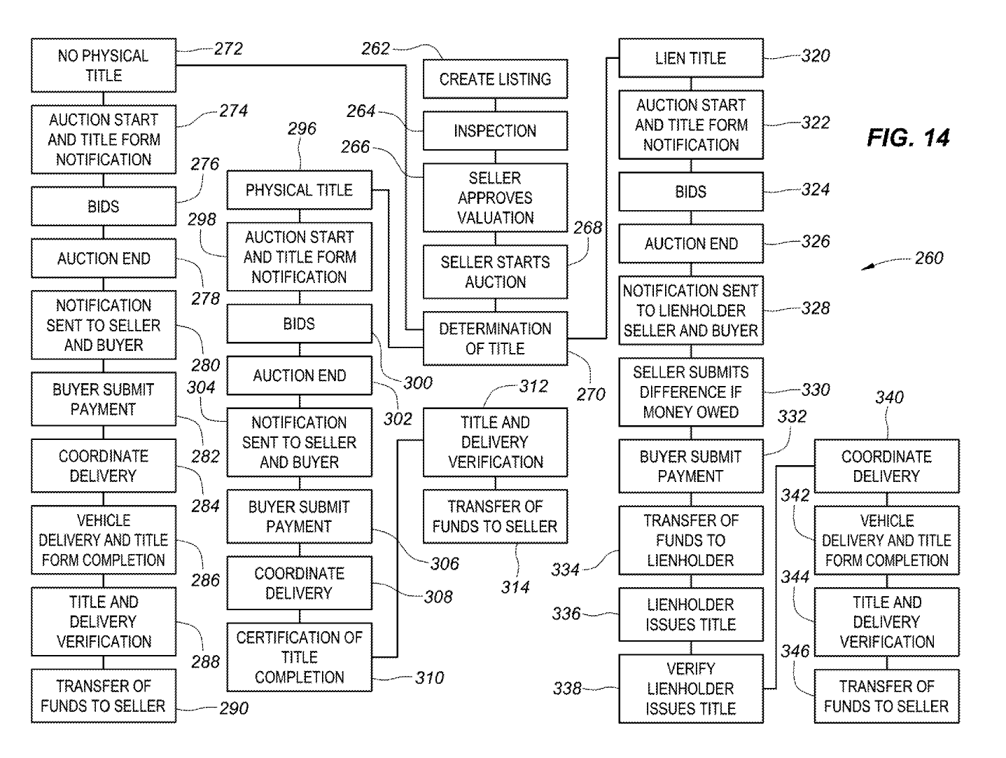

FIG. 14 depicts a flow chart for conducting a transaction, according to embodiments of the present disclosure. In some embodiments, individual steps in the flow chart 260 can be representative of computer readable instructions that can be executed by one or more of the computing devices discussed herein. In some embodiments, individual steps in the flow chart 260 can represent method steps, which can be executed by the one or more computing devices discussed herein. In some embodiments, a selection can be received at block 262 to create a listing for selling a vehicle. In an example, a clickwrap agreement can be accepted by the seller when creating the listing. In some embodiments, instructions can be included to complete an inspection of the vehicle by a third party company at block 264. Upon completion of the inspection, the results of the inspection can be associated with the vehicle listing. For example, the results of the inspection can be provided to the seller and/or displayed in conjunction with the listing. In some embodiments, the inspection can include a valuation of the vehicle, which can be provided to the seller. At block 266, a selection can be received from the seller to approve the valuation of the vehicle. The selection can be in response to a clickwrap agreement regarding approval of the valuation of the vehicle. Upon approval of the valuation, a selection can be received from the seller to start the auction at block 268. The selection received from the seller to start the auction can be in response to a clickwrap agreement regarding the terms of use of the auction, such as payment of auction fees to the auction company. In some embodiments, the user can choose to not accept the valuation and provide a valuation of their own.

In some embodiments, a determination of title can be made at block 270. In an example, the determination of title can be made in response to questions asked to a seller regarding the title of the vehicle. For example, a question regarding whether the vehicle is financed and/or owned outright can be posed to the seller. If the vehicle is owned outright by the seller, questions regarding whether the seller has a physical copy of the title can be posed to the seller. If the seller provides a response that the seller has no physical copy of the title, a determination can be made that no physical title exists at block 272. In some embodiments, a notification can be provided to the seller regarding a title form notification, which can provide information to the seller regarding completion of paperwork that is required for the sale of the vehicle at block 274. In an example, information can be provided to the seller regarding how to obtain a duplicate title. For instance, information regarding obtaining an application for duplicate or paperless title (e.g., REG 227 for the state of California) can be provided to the seller. In some embodiments, information regarding obtaining an application for vehicle transfer and reassignment (e.g., REG 262 for the state of California) can be provided to the seller. In some embodiments, block 274 can also include instructions to notify the seller that the auction has started.

Bids can be received at block 276 from potentially interested buyers. In some embodiments, a clickwrap can be provided to the potentially interested buyers, which must be accepted before they place a bid. After a predetermined time period and/or after a bid of a particular amount is received, the auction can end at block 278. In some embodiments, a notification can be provided to the seller and/or the buyer at block 280 regarding the end of the auction. In some embodiments, the seller notification can include a notification to bring the certificate of title to delivery; to sign an odometer reporting section of the certificate of title at delivery; provide information regarding obtaining the application for duplicate title or paperless title and information regarding obtaining an application for vehicle transfer and reassignment; and provide a link to notice of transfer and release of liability to fill out on a department of motor vehicles website after delivery. In some embodiments, the buyer notification can include a notification to submit funds into a trust account associated with the auction company as soon as possible and to provide a time when the deposit of funds is due. In some embodiments, the buyer notification can include a notification to sign the odometer reporting certificate of title and to register the vehicle once the vehicle is delivered.

In some embodiments, if the buyer is successful in their bid and wins the auction, a request can be sent to the buyer to submit a payment and a payment can be received from the buyer at block 282. Upon submission of the payment from the buyer, a clickwrap agreement can be presented to and accepted by the buyer associated with the terms of use of the auction and payment of auction fees.

In some embodiments, a payment from the buyer can be received in the trust account associated with the auction company at block 282. In some embodiments, the buyer and the seller can be notified to coordinate delivery of the vehicle at block 284. In some embodiments, at block 286, the vehicle can be delivered and the application for duplicate or paperless title and the application for vehicle transfer and reassignment can be signed by the buyer and/or seller. In some embodiments, at block 288, the title and delivery of the vehicle can be verified. In some embodiments, the documents associated with the transfer of title (e.g., REG 227, 262) can be verified. In an example, the seller can be provided with a notification, which includes a reminder to submit the notice of transfer and release of liability with the department of motor vehicles and the buyer can be provided with a notification, which includes a reminder to register the vehicle and pay sales tax on the vehicle. In some embodiments, a transfer of funds to the seller can be completed at block 290. The transfer of funds to the seller can include the funds provided by the buyer minus any transaction fees associated with the auction service.

In some embodiments, upon a determination that a physical title exists at block 296, a notification can be provided to the seller regarding a title form notification, which can provide information to the seller regarding completion of paperwork that is required for the sale of the vehicle at block 298. In some embodiments, the notification provided to the user can be a notification that includes information on obtaining a bill of sale (e.g., REG 135 for the state of California). In some embodiments, bids can be received from a potential buyer at block 300. As previously discussed, a clickwrap agreement can be presented to the buyer for acceptance.

The auction can be ended at block 302, as previously discussed herein. In some embodiments, a notification can be provided to the seller and the buyer at block 304. In an example, the seller notification can include a notification to bring the certificate of title to delivery; to sign an odometer reporting section of the certificate of title at delivery; a link to a bill of sale (e.g., REG 135); and/or a link to a transfer and release of liability form to fill out (e.g., on a website) after delivery. In some embodiments, as previously discussed, the buyer can submit a payment, which can include a fee for using the auction service at block 306. In some embodiments, a delivery of the vehicle can be coordinated between the buyer and seller at block 308.

In some embodiments, the certificate of title can be completed at block 310. For example, an odometer section of the certificate of title can be signed and a bill of sale can be signed by the buyer and the seller. In some embodiments, title and delivery verification can be completed at block 312. For example, the title and delivery of the vehicle can be verified. In some embodiments, the documents associated with the bill of sale can be verified. In an example, the seller can be provided with a notification, which includes a reminder to submit the notice of transfer and release of liability with the department of motor vehicles and the buyer can be provided with a notification, which includes a reminder to register the vehicle and pay sales tax on the vehicle. In some embodiments, a transfer of funds to the seller can be completed at block 314, as previously discussed herein.

In some embodiments, upon a determination that a lien title exists at block 320, a notification can be provided to the seller regarding a title form notification at block 322, which can provide information regarding obtaining an application for duplicate or paperless title (e.g., REG 227 for the state of California) to the seller. In some embodiments, information regarding obtaining an application for vehicle transfer and reassignment (e.g., REG 262 for the state of California) can be provided to the seller. In some embodiments, block 274 can also include instructions to notify the seller that the auction has started.

Block 324 can include receiving one or more bids on the vehicle from a potential buyer and the auction can end at block 326 upon expiration of a predetermined time period and/or upon a bidding reaching a predetermined amount. In some embodiments, a notification can be sent to the lienholder, the seller, and the buyer at block 328. In some embodiments, the notification to the seller can include an instruction to deposit the money owed on a lien associated with the vehicle; instructions to obtain and sign documents required for transfer of title (e.g. REG 262) and have the buyer sign the documents; and provide a link to a notice of transfer and release of liability for completion after delivery of the vehicle. In some embodiments, the notification to the buyer can include a notification to deposit funds required for purchasing the vehicle and to obtain and sign the documents required for transfer of title (e.g., REG 262) from the seller upon delivery; and to register the vehicle with the department of motor vehicles once they have the title.

In some embodiments, a notification can be generated requesting the seller to submit money to the lienholder if money is owed on the vehicle at block 330. In some embodiments, the difference between what the car has been sold for and the amount of money owed to the lienholder can be submitted by the seller. In some embodiments, the buyer can submit payment for the vehicle into a trust account at block 332. In an example, the payment can include a fee charge for the auction service.

At block 334, the amount of money owed on the vehicle can be dispersed from a trust account and transferred to the lienholder. Upon transfer of the money, the lienholder can sign and notarize the title and/or the application for duplicate or paperless title if the lienholder does not have the title, at block 336. At block 338, the auction service and/or a third party can verify that the lienholder has issued the title.

Upon verification that the lienholder has issued the title, a notification can be sent to the seller and buyer to coordinate delivery at block 340. In some embodiments, the vehicle can be delivered and documents associated with the transfer of title can be completed at block 342. In some embodiments, the buyer can verify that the vehicle and/or title has been delivered at block 344. In some embodiments, a notification can be provided to the buyer to register the vehicle and pay sales tax on the vehicle. In some embodiments, a notification can be provided to the seller to submit the notice of transfer and release of liability associated with the vehicle, for example on a department of motor vehicles website.

Embodiments are described herein of various apparatuses, systems, and/or methods. Additional aspects of the present disclosure will be made apparent upon review of the material in Appendix A, attached herewith. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment(s) is included in at least one embodiment. Thus, appearances of the phrases “in various embodiments,” “in some embodiments,” “in one embodiment,” or “in an embodiment,” or the like, in places throughout the specification, are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It will be appreciated that the terms “proximal” and “distal” may be used throughout the specification with reference to a clinician manipulating one end of an instrument used to treat a patient. The term “proximal” refers to the portion of the instrument closest to the clinician and the term “distal” refers to the portion located furthest from the clinician. It will be further appreciated that for conciseness and clarity, spatial terms such as “vertical,” “horizontal,” “up,” and “down” may be used herein with respect to the illustrated embodiments. However, surgical instruments may be used in many orientations and positions, and these terms are not intended to be limiting and absolute.

Although at least one embodiment for a system and method for facilitating a transaction has been described above with a certain degree of particularity, those skilled in the art could make numerous alterations to the disclosed embodiments without departing from the spirit or scope of this disclosure. All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the devices. Joinder references (e.g., affixed, attached, coupled, connected, and the like) are to be construed broadly and can include intermediate members between a connection of elements and relative movement between elements. As such, joinder references do not necessarily infer that two elements are directly connected and in fixed relationship to each other. It is intended that all matter contained in the above description or shown in the accompanying drawings shall be interpreted as illustrative only and not limiting. Changes in detail or structure can be made without departing from the spirit of the disclosure as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A computer implemented method for facilitating a transaction, comprising:
receiving a selection from a user;
characterizing the selection received from the user as a buy request associated with a vehicle;
receiving data associated with the vehicle from the user;
performing an aggregated vehicle search based on the data associated with the vehicle received from the user; and
determining, with a computer, a source of data accumulated as a result of the performance of the aggregated vehicle search.

2. The method of claim 1, further comprising determining that the source of the data accumulated as a result of the performance of the aggregated vehicle search is internal.

3. The method of claim 2, further comprising displaying information that is stored in an internal database in response to a determination that the source of the data accumulated as a result of the performance of the aggregated vehicle search is internal.

4. The method of claim 1, further comprising determining that the source of the data accumulated as a result of the performance of the aggregated vehicle search is external.

5. The method of claim 4, further comprising displaying the data accumulated as a result of the performance of the aggregated vehicle search with a view controller in response to the determination that the source of the data is external.

6. The method of claim 1, further comprising receiving personal information from the user.

7. The method of claim 6, further comprising performing the aggregated vehicle search based on the personal information received from the user.

8. The method of claim 6, wherein the personal information includes at least one of marital status, size of family, age, gender, anticipated activities that the vehicle will be used for, favorite color, and personality type.

9. The method of claim 1, wherein receiving data associated with the vehicle from the user includes:
receiving a plurality of characteristics associated with the vehicle from the user; and
receiving a plurality of weighting factors associated with each one of the characteristics associated with the vehicle from the user.

10. The method of claim 9, further comprising selecting a type of vehicle for the user based on the plurality of characteristics and the plurality of weighting factors received from the user.

11. The method of claim 1, wherein performing the aggregated vehicle search includes searching third party databases via their associated application programming interfaces.

12. The method of claim 1, wherein performing the aggregated vehicle search includes employing web scraping to pull data from databases that do not employ an application programming interface.

13. A non-transitory computer-readable medium storing instructions to facilitate a transaction, executable by a processing resource to:
receive a selection from a user;
characterize the selection received from the user as a sell request associated with a vehicle;
determine whether the sell request is a private sale request or a dealer sale request;
populate the vehicle in a listing as at least one of the private sale request and the dealer sale request, based on the selection received from the user.

14. The non-transitory computer-readable medium of claim 13, further comprising instructions executable by the processing resource to present user selectable options to the user, wherein each one of the user selectable options is derived based on a vehicle identification number associated with the vehicle that is received from the user.

15. The non-transitory computer-readable medium of claim 13, further comprising instructions executable by the processing resource to prompt the user to take a plurality of pictures of the vehicle in a sequential order.

16. The non-transitory computer-readable medium of claim 13, further comprising instructions executable by the processing resource to:
determine that a loan exists on the vehicle based on information obtained from the user; and
automatically send a notification to a loan company associated with the loan on the vehicle.

17. The non-transitory computer-readable medium of claim 16, further comprising instructions executable by the processing resource to automatically send the notification to the loan company upon sale of the vehicle.

18. A system for facilitating a transaction, comprising:
a processor and memory storing non-transitory computer-readable instructions, executable by the processor to:
receive a selection from a user;
characterize the selection received from the user as a buy request associated with a vehicle;
receive data associated with the vehicle from the user;
perform an aggregated vehicle search based on the data associated with the vehicle received from the user;
determine that a source of data accumulated via the aggregated vehicle search is external; and
display the data accumulated via the aggregated vehicle search with a view controller, based on the determination that the data accumulated via the aggregated vehicle search is external.

19. The system of claim 18, wherein the instructions executable to receive data associated with the vehicle from the user further include instructions executable to receive a plurality of desired characteristics associated with the vehicle and a rank of importance associated with each one of the plurality of desired characteristics.

20. The system of claim 19, further comprising instructions executable to select a vehicle listing based on the rank of importance associated with each of the plurality of desired characteristics.
